(19) United States
(12) Patent Application Publication
(10) Pub. No.: US 2023/0378500 A1
(43) Pub. Date: Nov. 23, 2023

(54) Fuel Cell Exhaust Gas Arrangement for a Fuel Cell System

(71) Applicant: Purem GmbH, Neunkirchen (DE)

(72) Inventors: Jochen Hammer, Stuttgart (DE); Markus Birgler, Wernau (DE); Volker Brichzin, Ludwigsburg (DE); Peter Wink, Goeppingen (DE); Patrick Schaller, Bopfingen (DE); Andreas Wacker, Plochingen (DE)

(21) Appl. No.: 18/320,501

(22) Filed: May 19, 2023

(30) Foreign Application Priority Data
May 20, 2022 (DE) 10 2022 112 683.8

(51) Int. Cl. H01M 8/04746; H01M 8/0267; H01M 8/04119

(52) U.S. Cl. CPC H01M 8/04761; H01M 8/0267; H01M 8/04164; H01M 2250/20

(57) ABSTRACT

A fuel cell exhaust gas arrangement for a fuel cell system includes a fuel cell exhaust gas line through which fuel cell exhaust gas can flow, and a separating unit through which the fuel cell exhaust gas can flow. The separating unit includes an upstream line portion of the fuel cell exhaust gas line through which the fuel cell exhaust gas can flow in a main exhaust gas flow direction. A downstream line portion of the fuel cell exhaust gas line adjoins the upstream line portion in an opening region. A first liquid outlet opening in the opening region is provided to outlet liquid from the fuel cell exhaust gas flowing through the fuel cell exhaust gas line. A swirl flow generating unit is provided in the upstream line portion.

### CROSS-REFERENCE TO RELATED APPLICATION

This application claims priority of German patent application no. 10 2022 112 683.8, filed May 20, 2022, the entire content of which is incorporated herein by reference.

### TECHNICAL FIELD

The present disclosure concerns a fuel cell exhaust gas arrangement for a fuel cell system, via which the process gas from a fuel cell can be output to the environment as fuel cell exhaust gas.

### BACKGROUND

In particular in electric motor operated vehicles, in order to be able to provide the energy for operating the drive electric motors and also the other consumers of electrical energy in such vehicles, it is known to use fuel cells. In operation of such a fuel cell, hydrogen or an anode gas strongly enriched with hydrogen is supplied to an anode region. Oxygen or oxygen-containing air as a cathode gas is supplied to a cathode region. Electrical current is generated during conversion of hydrogen and oxygen into water. The hydrogen-diminished anode exhaust gas and the water-enriched cathode exhaust gas leave the fuel cell as fuel cell exhaust gas or process gas. During fuel cell operation, at least the cathode exhaust gas is discharged to the environment. In various operating phrases, such as for example during flushing in particular of the anode region before start-up of the fuel cell operation, the anode exhaust gas or the gas conducted through the anode region in such an operating phase may also be discharged to the environment.

### SUMMARY

It is an object of the disclosure to provide a fuel cell exhaust gas arrangement for a fuel cell system, in particular in a vehicle, by means of which liquid carried in the fuel cell exhaust gas, in particular water, can be extracted from the fuel cell exhaust gas.

According to the disclosure, this object is, for example, achieved by a fuel cell exhaust gas arrangement for a fuel cell system, in particular in a vehicle, including a fuel cell exhaust gas line through which fuel cell exhaust gas can flow, and a separating unit through which the fuel cell exhaust gas can flow, wherein the separating unit includes:
an upstream line portion of the fuel cell exhaust gas line through which the fuel cell exhaust gas can flow in a main exhaust gas flow direction,
a downstream line portion of the fuel cell exhaust gas line adjoining the upstream line portion in an opening region,
a first liquid outlet opening in the opening region for outlet of liquid from the fuel cell exhaust gas flowing through the fuel cell exhaust gas line,
a swirl flow generating unit in the upstream line portion.

By use of the swirl flow generating unit, a swirl flow of the fuel cell exhaust gas is generated upstream of the annular first liquid outlet opening. The centrifugal forces acting in such a swirl flow cause liquid or liquid particles carried in the fuel cell exhaust gas to move radially outward, and hence a high liquid concentration occurs in the radially outer region of the fuel cell exhaust gas stream. The greater quantity of liquid collecting in the radially outer region of the fuel cell exhaust gas stream may then be discharged via the first liquid outlet opening.

The swirl flow generating unit may include a plurality of flow deflection elements following one another in the circumferential direction with respect to a flow center axis in the upstream line portion and skewed in the upstream line portion with respect to the main exhaust gas flow direction. Such swirl flow generating units constructed with a plurality of blade-like flow deflection elements are used for example as mixers in the exhaust gas systems of diesel combustion engines, in order to create a turbulence of the exhaust gas stream and hence support the mixing of exhaust gas and reduction agent injected therein, generally a urea/water solution, upstream of an SCR catalyst unit.

For an efficient flow deflection in order to generate the swirl flow, the flow deflection elements may extend radially inward from an annular body of the swirl flow generating unit, and/or the flow deflection elements adjacent to one another in the circumferential direction may overlap in the circumferential direction in their radially inner regions.

A simple structure, which can be achieved at low cost while being stable and resistant to corrosion, can be achieved if the swirl flow generating unit is formed together with the annular body and the flow deflection elements as a preferably integrally molded sheet-metal part. In a particularly advantageous embodiment with respect to corrosion resistance, production costs and configuration freedom in the construction, the swirl flow generating unit together for example with the annular body and the flow deflection elements may preferably be formed substantially integrally with plastic material.

In order to reliably support the discharge of liquid collecting in the radially outer region of the fuel cell exhaust gas stream, it is proposed that in the opening region, an upstream end portion of the downstream line portion is positioned engaging in a downstream end portion of the upstream line portion, such that the first liquid outlet opening is formed between the upstream end portion of the downstream line portion and the downstream end portion of the upstream line portion.

Here, an embodiment may be advantageous in which the downstream end portion of the upstream line portion is formed preferably widening substantially conically in the main exhaust gas flow direction, and/or the upstream end portion of the downstream line portion is formed preferably widening substantially conically in the main exhaust gas flow direction.

For reliable discharge from the radially outer region of the fuel cell exhaust gas stream with the high proportion of liquid, it may further be provided that the downstream line portion has a smaller cross-sectional dimension at its upstream end than the upstream line portion in its length region lying between the swirl flow generating unit and its downstream end. Furthermore, for this the first liquid outlet opening may be substantially annular.

The separating unit may include a separating unit housing, wherein the opening region is arranged in the separating unit housing. This ensures that, in particular where the first liquid outlet opening is formed, the fuel cell exhaust gas system is substantially closed towards the outside and no foreign bodies can enter.

Since it cannot be excluded that, despite generating a swirl flow, liquid may also be contained in the fuel cell exhaust gas system downstream of the first liquid outlet opening, it is proposed that the downstream line portion has a second liquid outlet opening downstream of the opening region. For this, for example, the downstream line portion may have a bend region in the separating unit housing with a bend apex to be positioned at the bottom in the vertical direction, wherein the second liquid outlet opening is arranged in the region of the bend apex.

In a region of the separating unit housing to be positioned at the bottom in the vertical direction, a liquid collection region may be provided having at least one liquid discharge opening for discharge of liquid from the separating unit housing.

In order to allow the outlet of liquid from the separating unit housing even at comparatively low temperatures, or in principle to avoid the freezing of liquid collecting in the liquid collection region, a heating unit may be assigned to the liquid collection region for heating liquid which has collected in the liquid collection region.

Since, for example on flushing of the anode region of a fuel cell, there is also a possibility that hydrogen-containing process gas may be output to the environment as fuel cell exhaust gas via the fuel cell exhaust gas system, to avoid over-enrichment of hydrogen in the separating unit housing, it is proposed that in a region of the separating unit housing to be positioned at the top in the vertical direction, a hydrogen collection region is provided having at least one hydrogen discharge opening for discharge of hydrogen from the separating unit housing.

Since the comparatively light hydrogen generally collects at the top in the vertical direction in the separating unit housing, it is advantageous for reliable output of hydrogen to the exterior if the hydrogen collection region includes a wall region of the separating unit housing which tapers towards the top in the vertical direction, wherein the at least one hydrogen discharge opening is provided in an upper apex region of the wall region.

In operation of a fuel cell, noise is generated for example by the generally electrically operated air compressors conveying the process gases, such as for example compressors; this may be considered disruptive in the environment of a vehicle or also by the vehicle occupants. It is therefore proposed that a silencer unit through which fuel cell exhaust gas can flow is provided, preferably downstream of the separating unit.

### BRIEF DESCRIPTION OF DRAWINGS

The invention will now be described with reference to the drawings wherein:

FIG. 1 shows a side view of a fuel cell exhaust gas arrangement;

FIG. 2 shows the fuel cell exhaust gas arrangement from FIG. 1 with open separating unit and silencer unit;

FIG. 3 shows in enlargement the silencer unit shown in FIG. 1;

FIG. 4 shows the separating unit shown in FIG. 2 in enlarged perspective view;

FIG. 5 shows the separating unit from FIG. 2 in enlarged side view;

FIG. 6 shows a detail view of region VI of the separating unit in FIG. 5;

FIG. 7 shows a perspective view of a swirl flow generating unit;

FIG. 8 shows an axial view of the swirl flow generating unit from FIG. 7; and,

FIG. 9 shows an illustration, corresponding to FIG. 8, of an alternative embodiment of the swirl flow generating unit.

### DETAILED DESCRIPTION

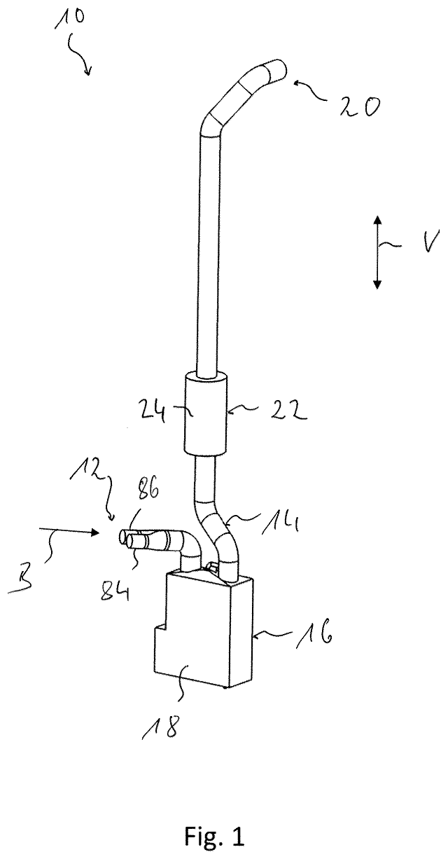

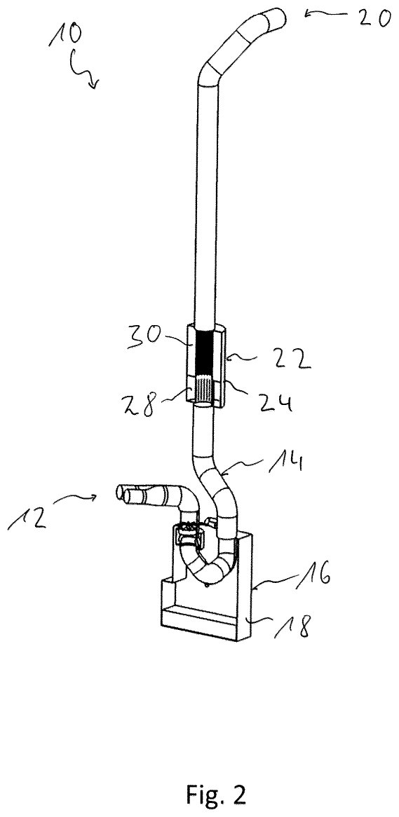

FIGS. FIGS. 1 and 2 show a fuel cell exhaust gas arrangement, generally designated 10, which may be used in particular in utility vehicles or trucks. The fuel cell exhaust gas arrangement 10 includes an inlet region 12 in which fuel cell exhaust gas B may enter a fuel cell exhaust gas line 14. Following the inlet region 12, the fuel cell exhaust gas arrangement 10 includes a separating unit 16 with a separating unit housing 18, shown cut-away or open in FIG. 1. The fuel cell exhaust gas line 14 passes through the separating unit housing 18 and, when the fuel cell exhaust gas arrangement 10 is installed in a vehicle, extends substantially upward in a vertical direction V from the separating unit housing 18. The fuel cell exhaust gas B leaves the fuel cell exhaust gas arrangement 10 in an outlet region 20.

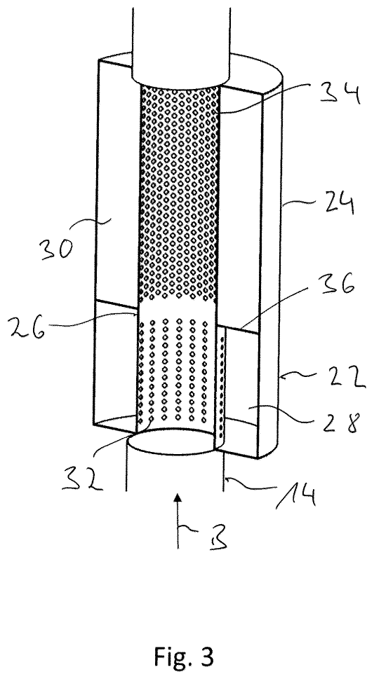

A silencer unit 22, shown in more detail in FIG. 3, is situated in the flow region between the separating unit 16 and the outlet region 20. The silencer unit 22 includes a tubular silencer housing 24 which surrounds the length portion 26 of the fuel cell exhaust gas line 14 lying in the region of the silencer unit 22. In the length portion 26, openings 32, 34 are provided which are assigned to two respective silencer chambers 28, 30 bordered by the silencer unit housing 24, so that a connection exists between the inner volume of the fuel cell exhaust gas line 14 in the length region 26 and the silencer chambers 28, 30. The silencer chambers 28, 30 may be separated from one another by a partition wall 36. It is pointed out that, as shown in FIG. 3, different numbers of and/or differently dimensioned openings 32, 34 may be provided which are assigned to the two silencer chambers 28, 30 in the length portion 26. Also, one or both silencer chambers 28, 30 may be partially or completely filled with sound-insulating material, for example, foamed material or fibrous material. It is pointed out that the silencer unit 22 is shown merely as an example in FIG. 3 and evidently could also be configured differently.

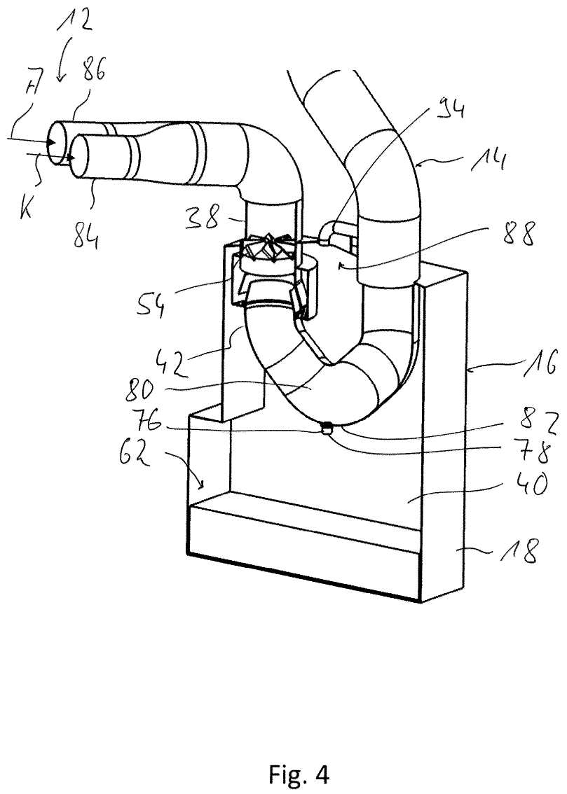

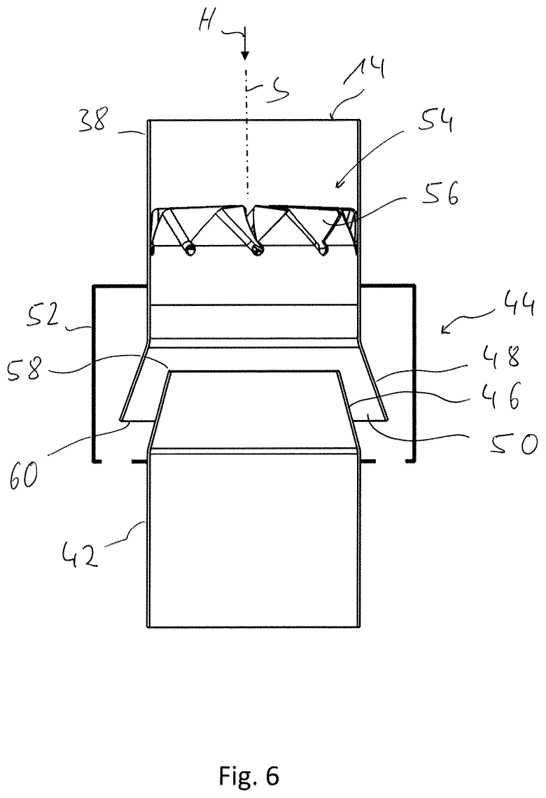

The separating unit 16 is described in more detail below with reference to FIGS. 4 to 6.

An upstream tubular line portion 38, configured for example with circular cross-section and elongated in the direction of the flow center axis S, of the fuel cell exhaust gas line 14 leads into the separating unit housing 18 downstream of the inlet region 12. In an interior 40 of the separating unit housing 18, a downstream line portion 42 of the fuel cell exhaust gas line 14 adjoins the upstream line portion 38. In an opening region 44, an upstream end region 46 of the downstream line portion 42 is positioned engaging in a downstream end region 48 of the upstream line portion 38. For this, the downstream end region 48 of the upstream line portion 38 is formed widening substantially conically along the flow center axis S, which may substantially correspond to the center axis of the rectilinearly extending upstream line portion 38. Similarly, the upstream end region 46 of the downstream line portion 42, which extends into the downstream end region 48 of the upstream line portion 38, is formed preferably widening substantially conically along the flow center axis S and in the direction of a main exhaust gas flow direction H in which the fuel cell exhaust gas B flows through the upstream line portion 38.

Between the mutually substantially complementarily, radially widening end portions 46, 48, an annular first liquid outlet opening 50 is formed, via which the fuel cell exhaust gas line 14 opens into the interior 40 of the separating unit housing 18. In the region of the first liquid outlet opening 50, or in the region in which the two line portions 38, 42 adjoin one another, the fuel cell exhaust gas line 14 may be covered by a housing element 52 which may be open in its lower region in the vertical direction V into the interior 40 of the separating unit housing 18.

Upstream of the first liquid outlet opening 50 or the radially widening downstream end region 48 of the upstream line portion 38, a swirl flow generating unit 54 is arranged therein. The swirl flow generating unit 54 includes a plurality of blade-like flow deflection elements 56 extending substantially radially and following one another in the circumferential direction about the flow center axis S. The flow deflection elements 56 are skewed relative to the main exhaust gas flow direction H, that is, not parallel and also not angled at an angle of 90° thereto, so that the fuel cell exhaust gas B, flowing onto the swirl flow generating unit 58 in the main exhaust gas flow direction H, is deflected in the circumferential direction on hitting the flow deflection elements 56, thereby generating a swirl flow.

It is pointed out that such swirl flow generating units are used for example as mixers in exhaust gas systems of diesel combustion engines. The exhaust gas flowing in such an exhaust gas system of a diesel combustion engine is eddied by the generated swirl flow, so as to achieve an efficient mixing of exhaust gas with reduction agent injected therein, for example, a urea/water solution, and the resulting mixture of exhaust gas and reduction agent is conducted into an SCR catalyst unit.

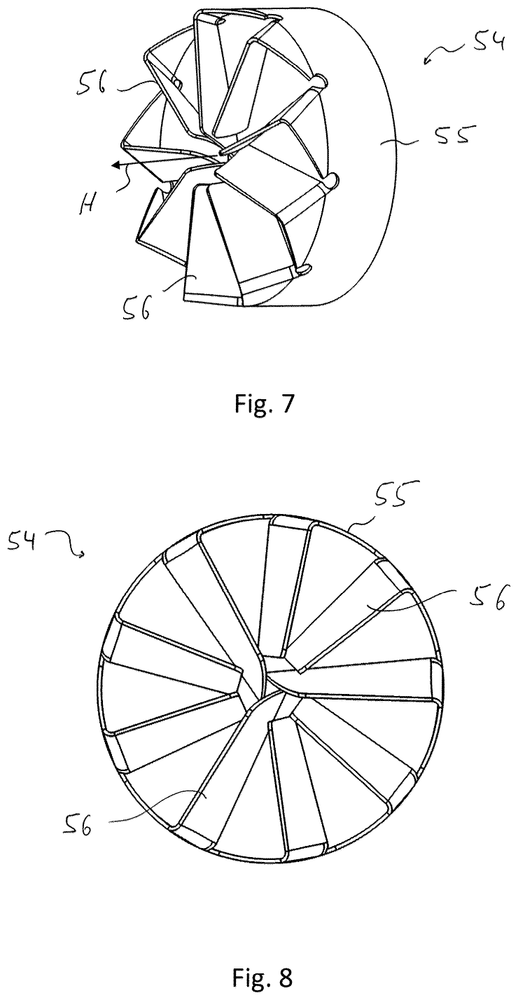

FIGS. 7 to 9 show in more detail an embodiment of the swirl flow generating unit 54 which may be used in the fuel cell exhaust gas arrangement 10. This may for example be bent integrally from sheet-metal material and includes an annular or substantially cylindrical body 55, via which the swirl flow generating unit 68 may be held for example on the upstream line portion 38. The blade-like flow deflection elements 56 arranged successively in the circumferential direction extend radially inward from the body 55, so that for example their radially inner end regions partially overlap in the circumferential direction. The flow deflection elements 56 are skewed relative to the main exhaust gas flow direction H, that is, tilted at an angle different from 90°, so that the fuel cell exhaust gas, flowing onto the swirl flow generating unit 54 in the main exhaust gas flow direction H, is deflected on the flow deflection elements 56 in the circumferential direction relative to the flow center axis S and a swirl flow is generated.

In an alternative embodiment, the swirl flow generating unit 54 may be made of plastic material. This leads to a lightweight structure which is cheap to produce, in which the swirl flow generating unit 54 has a high corrosion resistance, in particular with respect to the water contained in the fuel cell exhaust gas.

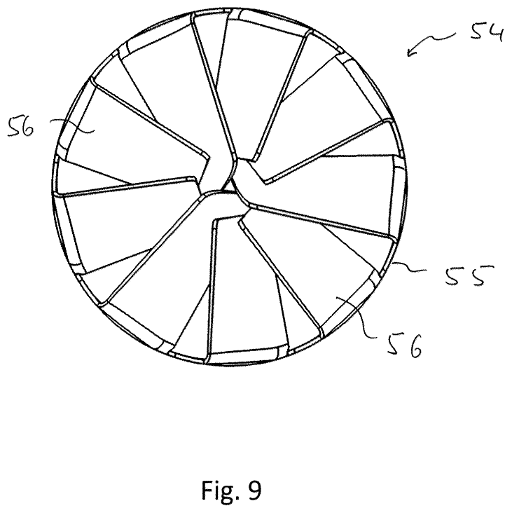

The degree of deflection in the circumferential direction, and hence the amount of the generated swirl flow but simultaneously also the amount of the flow obstruction created by the flow deflection elements 56, depends on the skew angle of the flow deflection elements 56 relative to the main exhaust gas flow direction H. In the embodiment shown in FIGS. 7 and 8, the flow deflection elements 56 are comparatively slightly skewed, that is, oriented more in the direction of the main exhaust gas flow direction H, so that a slighter deflection of the fuel cell exhaust gas stream in the circumferential direction occurs. FIG. 9 shows an embodiment of the swirl flow generating unit 54 in which the flow deflection elements 56, which also stretch further in the circumferential direction, are skewed more greatly relative to the main exhaust gas flow direction. With the configuration of the swirl flow generating unit 54 shown in FIG. 9, the fuel cell exhaust gas stream is deflected more strongly in the circumferential direction, which contributes to an increased centrifugal force acting on the liquid particles contained in the fuel cell exhaust gas.

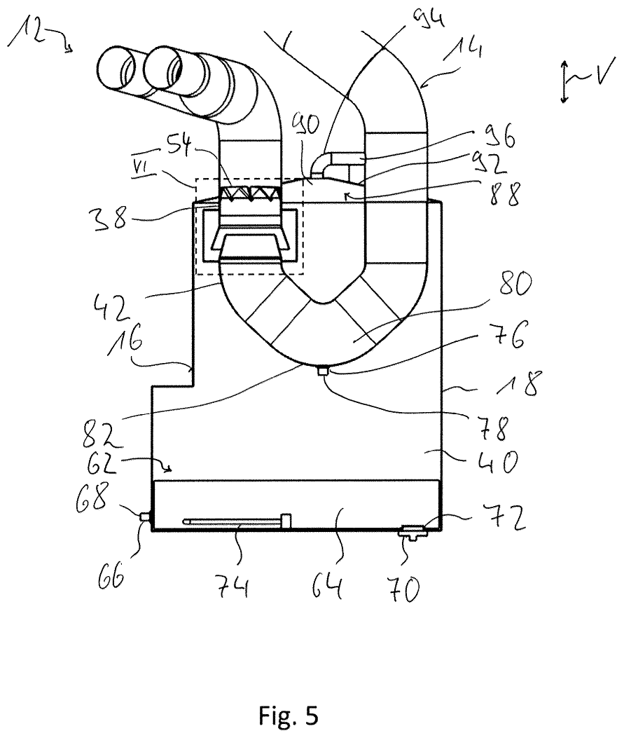

The deflection of the fuel cell exhaust gas stream in the circumferential direction and the resulting swirl flow lead to centrifugal forces which fling the liquid or liquid droplets transported in the fuel cell exhaust gas B radially outward. This means that downstream of the swirl flow generating unit 54, a comparatively high concentration of liquid transported in the fuel cell exhaust gas B occurs in the radially outer region of the fuel cell exhaust gas stream. In particular because of the transition of the two line portions 38, 42 shown in FIG. 5, and above all because the upstream end 58 of the downstream line portion 42 has a cross-sectional dimension, that is, a diameter for a circular configuration, which is smaller than the cross-sectional dimension of the upstream line portion 38 in its length region extending between the swirl flow generating unit 54 and its downstream end 60, in particular also in its downstream end region 48 reaching over the upstream end region 46 of the downstream line portion 42, the part of the fuel cell exhaust gas stream enriched with liquid enters the first liquid outlet opening 50, so that in particular also the liquid carried in this part of the fuel cell exhaust gas stream reaches the interior 40 and is thus extracted from the remainder of the fuel cell exhaust gas stream which, with reduced liquid content, enters the downstream line portion 42.

A liquid collection region 62 is formed in a lower region of the separating unit housing 18 in the vertical direction V. In the embodiment shown, the liquid collection region 62 is formed with a dish-like collection container 64 which is open at the top and inserted in the lower region of the interior 40 of the separating unit housing 18. In the region of a discharge connector 66 passing through the separating unit housing 18, a first liquid discharge opening 68 is formed via which liquid can be discharged from the separating unit housing 18. For example, a valve may be assigned to the discharge connector 66 in order to output liquid at defined times and return this for example to the fuel cell process.

A second liquid discharge opening 72 may be provided in a floor region of the liquid collection container 64, or also the separating unit housing 18, which opening is closed by a closure element 70 and via which the separating unit housing 18 can be completely drained, for example on performance of maintenance work.

Furthermore, an electrically excitable heater unit 74, for example a heating spiral or similar, may be provided in the liquid collection region 62, for example on a floor region of the liquid collection container 64 or separating unit housing 18. This heating unit 74 can heat the liquid collecting in the liquid collection region 62 so as to prevent it from freezing, in particular at comparatively low ambient temperatures, or to be able to discharge liquid from the liquid collection region 62 even during frosts or at low ambient temperatures. It is pointed out that the liquid collection region 62 may also be formed without the liquid collection container 64, and the discharge connector 66 may for example be formed directly on the separating unit housing 18.

Since it cannot be excluded that the part of the fuel cell exhaust gas B entering the downstream line portion 42 still contains liquid despite generation of a swirl flow upstream of the opening region 44, a second liquid outlet opening 78 is formed in the downstream line portion 42, for example in the region of a discharge connector 76. The downstream line portion 42 has a knee-like bend region 80 in its length region extending into the interior 40 of the separating unit housing 18, which region forms a bend apex 82 positioned or to be positioned at the bottom in the vertical direction V. In the region of this bend apex 82, the second liquid outlet opening 78 is arranged so that downstream of the opening region 44, liquid collecting for example because of condensation can collect at the lowest region of the fuel cell exhaust gas line 14 downstream of the opening region 44 and leave the fuel cell exhaust gas line 14 in the direction towards the liquid collection region 62.

The need to extract liquid from the fuel cell exhaust gas B, in particular so that this can be further used in the fuel cell operation, primarily exists if the fuel cell exhaust gas B includes process gas leaving the cathode region of a fuel cell, that is, cathode exhaust gas K, which is conducted through the fuel cell exhaust gas system. At the start of operation of a fuel cell system, it may be necessary to flush the anode region of the fuel cell with gas. This gas, carrying hydrogen which may still be present in the anode region out of the anode region, may also be conducted into the fuel cell exhaust gas system as anode exhaust gas A and be discharged towards the outside via this. For this, in the inlet region 12, the fuel cell exhaust gas line 14 may have two inlet ports 84, 86 which are respectively connected, or can be connected via corresponding valve arrangements, to the cathode region for receiving the cathode exhaust gas K or the anode region for receiving the anode exhaust gas A, in order to be able to conduct in targeted fashion one or both of these exhaust gas streams through the fuel cell exhaust gas arrangement 10. It is pointed out that the anode regions or the cathode regions of multiple fuel cells or fuel cells stacks of a fuel cell system are or may be connected to the fuel cell exhaust gas arrangement 10, for example via the inlet ports 84, 86.

If hydrogen-containing anode exhaust gas A is conducted through the fuel cell exhaust gas arrangement 10, in principle it is possible for hydrogen to enter the interior 40 of the separating unit housing 18 via the first liquid outlet opening 50 or the second liquid outlet opening 78. The hydrogen, which is significantly lighter than air or oxygen and nitrogen, will collect in the upper region, in the vertical direction V, of the interior 40 of the separating unit housing 18. In order to avoid the occurrence of a potentially hazardous high hydrogen concentration, therefore a hydrogen collection region 88 is formed in this region of the separating unit housing 18 positioned at the top in the vertical direction V. In this region, the separating unit housing 18 is formed with a wall region 92 which tapers upward in the vertical direction V into an upper apex region 90 which, in the manner of a hopper, conducts the upwardly mobile hydrogen towards the upper apex region 90. In the upper apex region 90, a discharge pipe 94 adjoins the wall region 92 and provides a preferably permanently open hydrogen discharge opening 96. Hydrogen conducted into the interior 40 is thus, because of its tendency to move upward, conducted into the apex region 90 and output to the environment in fundamentally non-critical concentrations via the hydrogen discharge opening 96.

The provision of the hydrogen collection region 88, formed with the substantially permanently open hydrogen discharge opening 96, furthermore means that the interior 40 of the separating unit housing 18 is in principle not permanently closed. This avoids the occurrence of build-up pressure in the fuel cell exhaust gas stream conducted through the fuel cell exhaust gas line 14, and thus also allows fuel cell exhaust gas B containing high liquid concentrations to escape from the fuel cell exhaust gas line 14 substantially without build-up via the first liquid outlet opening 50. Also, the presence of the second liquid outlet opening 78 prevents the occurrence of such a build-up pressure in the interior 40 of the separating unit housing 18.

With a fuel cell exhaust gas arrangement constructed according to the disclosure, it is possible for liquid particles contained in the fuel cell exhaust gas, in particular water vapor or water droplets, to be efficiently extracted from the fuel cell exhaust gas with little back-pressure or pressure loss. This allows a significantly more efficient operation of a fuel cell, since this can be operated for example with lower compressor power because of the lower back-pressure or flow resistance in the region of the fuel cell exhaust gas system.

In the fuel cell exhaust gas system, as well as the swirl flow generating unit, other system regions, such as for example the fuel cell exhaust gas line, the separating unit and the silencer unit, may be constructed for example substantially completely of plastic material. This contributes to a construction of a lightweight fuel cell exhaust gas system with low production cost. The construction with plastic material furthermore leads to very good corrosion resistance and great freedom of configuration of various components of the fuel cell exhaust gas system.

It is furthermore pointed out that such a fuel cell exhaust gas system may also be used in conjunction with stationary fuel cell systems, or for example those operated in ships or similar.

It is understood that the foregoing description is that of the preferred embodiments of the invention and that various changes and modifications may be made thereto without departing from the spirit and scope of the invention as defined in the appended claims.

1. A fuel cell exhaust gas arrangement for a fuel cell system including a vehicle, the fuel cell exhaust gas arrangement comprising:
a fuel cell exhaust gas line for accommodating a flow of fuel cell exhaust gas therethrough;
a separator accommodating the flow of fuel cell exhaust gas therethrough;
the separator including:
an upstream line portion of said fuel cell exhaust gas line through which the fuel cell exhaust gas can flow in a main exhaust gas flow direction (H);
a downstream line portion of the fuel cell exhaust gas line communicating with the upstream line portion in an opening region;
a first liquid outlet opening in said opening region for outletting liquid from the fuel cell exhaust gas flowing through said fuel cell exhaust gas line; and,
a swirl flow generator in said upstream line portion.

2. The fuel cell exhaust gas arrangement of claim 1, wherein said swirl flow generator includes a plurality of flow deflectors following one another in a circumferential direction with respect to a flow center axis (S) in said upstream line portion; and, said deflectors are skewed in said upstream line portion with respect to the main exhaust gas flow direction (H).

3. The fuel cell exhaust gas arrangement of claim 2, wherein said swirl flow generator includes an annular body; and, at least one of the following applies:
i) said flow deflectors extend radially inward from said annular body; and,
ii) said flow deflectors are disposed one adjacent to the other in said circumferential direction and overlap in said circumferential direction in radially inner regions thereof.

4. The fuel cell exhaust gas arrangement of claim 3, wherein one of the following applies:
i) said swirl flow generator is formed conjointly with said annular body and said flow deflectors; or,
ii) said swirl flow generator is formed conjointly with said annular body and said flow deflectors as an integrally molded sheet-metal part; or,
iii) said swirl flow generator is formed with plastic material.

5. The fuel cell exhaust gas arrangement of claim 1, wherein an upstream end portion of said downstream line portion is positioned engaging in a downstream end portion of said upstream line portion in said opening region so as to cause said first liquid outlet opening to be formed between said upstream end portion of said downstream line portion and said downstream end portion of said upstream line portion.

6. The fuel cell exhaust gas arrangement of claim 5, wherein at least one of the following applies:
i) said downstream end portion of said upstream line portion is formed in the main exhaust gas flow direction (H);
ii) said downstream end portion of said upstream line portion is formed widening conically in said main exhaust gas flow direction (H);
iii) said upstream end portion of said downstream line portion is formed in said main exhaust gas flow direction (H); and,
iv) said upstream end portion of said downstream line portion is formed widening conically in said main exhaust gas flow direction (H).

7. The fuel cell exhaust gas arrangement of claim 1, wherein at least one of the following applies:
i) said downstream line portion has a smaller cross-sectional dimension at said upstream end thereof than said upstream line portion in length regions thereof lying between said swirl flow generator and the downstream end thereof; and,
ii) said first liquid outlet opening is an annular opening.

8. The fuel cell exhaust gas arrangement of claim 1, wherein said separator has a separator housing and said opening region is arranged in said separator housing.

9. The fuel cell exhaust gas arrangement of claim 1, wherein said downstream line portion has a second liquid outlet opening downstream of said opening region.

10. The fuel cell exhaust gas arrangement of claim 8, wherein said downstream line portion has a bend region in said separator housing with a bend apex at bottom in a vertical direction (V); and, said second liquid outlet opening is arranged in the region of said bend apex.

11. The fuel cell exhaust gas arrangement of claim 8, wherein said separator housing defines a vertically downward region; and, said fuel cell exhaust gas arrangement further comprises a liquid collector arranged in said downward region and having at least one liquid discharge opening for discharging liquid from said separator housing.

12. The fuel cell exhaust gas arrangement of claim 11, further comprising a heater assigned to said liquid collector for heating liquid collected in said liquid collector.

13. The fuel cell exhaust gas arrangement of claim 8, wherein said separator housing defines a vertically upward region; and, said fuel cell exhaust gas arrangement further comprises a hydrogen collector disposed in said vertically upward region and having at least one hydrogen discharge opening for discharging hydrogen from said separator housing.

14. The fuel cell exhaust gas arrangement of claim 13, wherein said hydrogen collector includes a wall region of said separator housing tapered toward said vertically upward region in vertical direction (V); and, said at least one hydrogen discharge opening is provided in an upper apex region of said wall region.

15. The fuel cell exhaust gas arrangement of claim 1, further comprising a silencer through which the fuel cell exhaust gas can flow.

16. The fuel cell exhaust gas arrangement of claim 15, wherein said silencer is arranged downstream of said separator.
